(19) United States
(12) Patent Application Publication
(10) Pub. No.: US 2020/0231770 A1
(43) Pub. Date: Jul. 23, 2020

(54) OPTICAL FILM, PRODUCTION METHOD, AND MULTILAYER FILM

(71) Applicant: ZEON CORPORATION, Chiyoda-ku, Tokyo (JP)

(72) Inventor: Sogo KOMOTO, Tokyo (JP)

(73) Assignee: ZEON CORPORATION, Chiyoda-ku, Tokyo (JP)

(21) Appl. No.: 16/476,627

(22) PCT Filed: Jan. 18, 2018
(86) PCT No.: PCT/JP2018/001453

§ 371 Date: Jul. 9, 2019

(30) Foreign Application Priority Data
Jan. 31, 2017 (JP) 2017-015994

(51) Int. Cl. C08J 5/18; G02B 1/04; G02B 1/12

(52) U.S. Cl. CPC C08J 5/18; C08J 2487/00; G02B 1/12; G02B 1/04

(57) ABSTRACT

An optical film including, as a main component, a crystallized resin containing an alicyclic structure-containing polymer, wherein a crystallization degree of the crystallized resin is 30% or more, and an arithmetic average roughness of at least one face thereof is 2.5 nm or less. Preferably, in a surface layer on the side of at least one face, a composition ratio of an oxygen element relative to a carbon element is 1/10 or more, and a composition ratio of a nitrogen element relative to a carbon element is 1/20 or less. Also provided is a multilayer film including: the optical film; an adherend layer; and an adhesive layer provided between the optical film and the adherend layer.

### FIELD

The present invention relates to an optical film, a method for producing the optical film, and a multilayer film including the optical film.

### BACKGROUND

A resin optical film has often been disposed to a display device such as a liquid crystal display device and an organic electroluminescent display device. For example, it has been known that in a display device such as a touch panel having a function of detecting an action by a user, a flexible resin optical film is disposed to the surface of the display device to constitute a touch sensor.

Such an optical film is required to have properties such as heat resistance and flexibility. As a film having such properties, there has been proposed a film including a crystallized resin containing an alicyclic structure-containing polymer (for example, Patent Literatures 1 and 2).

### CITATION LIST

### Patent Literature

Patent Literature 1: Japanese Patent Application Laid-Open No. 2014-105291 A

Patent Literature 2: Japanese Patent Application Laid-Open No. 2016-008283 A

### SUMMARY

### Technical Problem

An optical film incorporated in a display device is required to have, in addition to the above-described properties, adhesiveness, that is, a capability to easily achieve the adhesion between the optical film and another component of the device. For example, an optical film constituting a touch sensor is required to be capable of adhering to another element constituting the touch sensor with high peel strength in order to increase the durability of the device itself. However, with the prior-art films using a crystallized resin containing an alicyclic structure-containing polymer, it is difficult to achieve the above-described high adhesiveness, and the prior-art films tend to cause delamination.

Therefore, an object of the present invention is to provide: an optical film having high heat resistance, high flexibility, and high adhesiveness; a method for easily producing the optical film; and a multilayer film which has high heat resistance and high flexibility, suppresses delamination, and has high durability.

### Solution to Problem

The present inventor conducted research for solving the aforementioned problem. As a result, the present inventor has found that when an optical film includes as a main component a crystallized resin containing an alicyclic structure-containing polymer, the crystallization degree of the crystallized resin is 30% or more, and the arithmetic average roughness of at least one face of the optical film is 2.5 nm or less, the high heat resistance, high flexibility, and high adhesiveness can be achieved, and delamination can be suppressed. Furthermore, the present inventor has found that the optical film having the above-described properties can be easily obtained by subjecting a crystallized resin film obtained by crystallizing a crystallizable resin film including an alicyclic structure-containing polymer to a plasma treatment. The present invention has been accomplished on the basis of such knowledge.

According to the present invention, the following is provided.

<1> An optical film comprising, as a main component, a crystallized resin containing an alicyclic structure-containing polymer, wherein

a crystallization degree of the crystallized resin is 30% or more, and

an arithmetic average roughness of at least one face thereof is 2.5 nm or less.

<2> The optical film according to <1>, wherein

in a surface layer on the side of at least one face, a composition ratio of an oxygen element relative to a carbon element is 1/10 or more, and

a composition ratio of a nitrogen element relative to a carbon element is 1/20 or less.

<3> The optical film according to <1> or <2>, wherein,

at least one face has a total surface free energy of 70 mN/m or more, a surface free energy of a dispersive component of 40 mN/m or less, a surface free energy of a polar component of 25 mN/m or more, and a surface free energy of a hydrogen-bond component of 10 mN/m or more.

<4> A method for producing the optical film according to any one of <1> to <3>, comprising:

a step of crystallizing a crystallizable resin film containing an alicyclic structure-containing polymer to obtain a crystallized resin film; and

a plasma treatment step of performing a plasma treatment on the crystallized resin film.

<5> The method for producing the optical film according to <4>, wherein the plasma treatment is performed under atmospheric pressure.
<6> The method for producing the optical film according to <4> or <5>, wherein

the plasma treatment is performed in a gas atmosphere,

the gas contains nitrogen gas, and also contains one or more gasses selected from oxygen gas and carbon dioxide gas, and

a weight ratio of oxygen relative to nitrogen in the gas is 5.50×10⁻³ or more and 1.30×10⁻¹ or less.

<7> The method for producing the optical film according to any one of <4> to <6>, wherein

the plasma treatment is performed in a gas atmosphere,

the gas contains nitrogen gas and oxygen gas, and

a weight ratio of oxygen to nitrogen in the gas is 5.50×10⁻³ or more and 3.50×10⁻² or less.

<8> The method for producing the optical film according to any one of <4> to <7>, wherein

the plasma treatment is performed in a gas atmosphere,

the gas contains nitrogen gas and carbon dioxide gas, and

a weight ratio of oxygen to nitrogen in the gas is 2.50×10⁻² or more and 1.30×10⁻¹ or less.

<9> A multilayer film comprising:

the optical film according to any one of <1> to <3>;

an adherend layer; and

an adhesive layer provided between the optical film and the adherend layer.

### Advantageous Effects of Invention

The optical film of the present invention has high heat resistance, high flexibility, and high adhesiveness. According to the method for producing the optical film of the present invention, such an optical film can be easily produced. The multilayer film of the present invention has high heat resistance, high flexibility, and high adhesiveness, and also suppresses delamination, and has high durability.

### DESCRIPTION OF EMBODIMENTS

Hereinafter, the present invention will be described in detail with reference to embodiments and examples. However, the present invention is not limited to the following embodiments and examples, and may be freely modified for implementation without departing from the scope of claims of the present invention and the scope of their equivalents.

In the following description, a “long-length” film refers to a film having a length that is 5 times or more the width, and preferably a film having a length that is 10 times or more the width, and specifically refers to a film having a length that allows the film to be wound up into a rolled shape for storage or transportation. The upper limit of the ratio of the length of the film relative to the width thereof is not particularly limited, and may be 100,000 times or less the width, for example.

In the following description, a direction of an element being “parallel”, “perpendicular” or “orthogonal” may allow an error within the range of not impairing the advantageous effects of the present invention, for example, within a range of ±5°, unless otherwise specified.

[1. Optical Film]

The optical film of the present invention includes, as a main component, a crystallized resin containing an alicyclic structure-containing polymer, and the crystallization degree of the crystallized resin is 30% or more. Also, the arithmetic average roughness of at least one face of the optical film of the present invention is 2.5 nm or less. The “main component” refers to a component of which the containing amount is 50% by weight or more of the entirety (the same applies hereinafter). The optical film of the present invention may include an optional component other than the crystallized resin, or may include only the crystallized resin. That is, the upper limit of the ratio of the crystallized resin in the optical film may be 100% by weight.

In the present invention, the crystallization degree of the crystallized resin is 30% or more, preferably 50% or more, and more preferably 60% or more. The upper limit of the crystallization degree is ideally 100%, and may be usually 90% or less, or 80% or less.

The crystallization degree is an index which indicates the ratio of the crystallized alicyclic structure-containing polymer in the crystallizable alicyclic structure-containing polymer included in the optical film. In the present invention, the optical film contains a crystallizable alicyclic structure-containing polymer of which 30% or more has been crystallized. The crystallization degree of the alicyclic structure-containing polymer included in the optical film may be measured by X-ray diffraction method. Specifically, according to JIS K0131, a wide angle X-ray diffraction device (for example, RINT 2000, manufactured by Rigaku Corporation) is used to obtain an intensity of diffracted X-ray from a crystallizable portion, and the crystallization degree may be calculated from the ratio relative to the intensity of entire diffracted X-ray, according to the following formula (I).

Xc=K·Ic/It (I)

In the above-described formula (I), Xc represents a crystallization degree of a test sample, Ic represents an intensity of diffracted X-ray from a crystallizable portion, It represents an intensity of entire diffracted X-ray, and K represents a correction term.

The crystallized resin may be formed by crystallizing a crystallizable resin containing an alicyclic structure-containing polymer.

The alicyclic structure-containing polymer refers to a polymer that has an alicyclic structure in the molecule and can be obtained by a polymerization reaction using a cyclic olefin as a monomer, or a hydrogenated product thereof. As the alicyclic structure-containing polymer, one type thereof may be solely used, and two or more types thereof may also be used in combination at any ratio.

Examples of the alicyclic structure contained in the alicyclic structure-containing polymer may include a cycloalkane structure, and a cycloalkene structure. Among these, from the viewpoint of easily obtaining an optical film excellent in properties such as thermal stability, a cycloalkane structure is preferable. The number of carbon atoms contained in one alicyclic structure is preferably 4 or more, and more preferably 5 or more, and is preferably 30 or less, more preferably 20 or less, and particularly preferably 15 or less. When the number of carbon atoms contained in one alicyclic structure falls within the above-described range, mechanical strength, heat resistance, and moldability are highly balanced.

In the alicyclic structure-containing polymer, the ratio of the structural unit having an alicyclic structure relative to all structural units is preferably 30% by weight or more, more preferably 50% by weight or more, and particularly preferably 70% by weight or more. When the ratio of the structural unit having an alicyclic structure in the alicyclic structure-containing polymer is at a high level as described above, the advantageous effects of the present invention such as high flexibility can be enhanced. The upper limit of the ratio of the structural unit having an alicyclic structure may be 100% by weight.

In addition, in the alicyclic structure-containing polymer, the remainder other than the structural unit having an alicyclic structure is not particularly limited, and may be appropriately selected depending on the purpose of use.

The alicyclic structure-containing polymer included in the crystallizable resin has crystallizability. The “alicyclic structure-containing polymer having crystallizability” refers to an alicyclic structure-containing polymer having a melting point Tm (that is, a melting point thereof can be observed by a differential scanning calorimeter (DSC)). The melting point Tm of the alicyclic structure-containing polymer is preferably 200° C. or higher, and more preferably 230° C. or higher, and is preferably 290° C. or lower. When the alicyclic structure-containing polymer having such a melting point Tm is used, a desired crystallization degree in the present invention can be easily achieved.

The weight-average molecular weight (Mw) of the alicyclic structure-containing polymer is preferably 1,000 or more, and more preferably 2,000 or more, and is preferably 1,000,000 or less, and more preferably 500,000 or less. The alicyclic structure-containing polymer having such a weight-average molecular weight has excellent balance of molding processability and flexibility.

The molecular weight distribution (Mw/Mn) of the alicyclic structure-containing polymer is preferably 1.0 or more, and more preferably 1.5 or more, and is preferably 4.0 or less, and more preferably 3.5 or less. Herein, Mn represents a number-average molecular weight. The alicyclic structure-containing polymer having such a molecular weight distribution has excellent molding processability.

The weight-average molecular weight (Mw) and the molecular weight distribution (Mw/Mn) of the alicyclic structure-containing polymer may be measured as a polystyrene-equivalent value by gel permeation chromatography (GPC) using tetrahydrofuran as a developing solvent.

The glass transition temperature Tg of the alicyclic structure-containing polymer is not particularly limited, and is usually 85° C. or higher and is usually 170° C. or lower.

Examples of the alicyclic structure-containing polymer may include the following polymer (α) to polymer (δ). Among these, the polymer (β) is preferable as the alicyclic structure-containing polymer having crystallizability because the optical film having excellent flexibility can be easily obtained therewith.

Polymer (α): a ring-opening polymer of a cyclic olefin monomer, having crystallizability

Polymer (β): a hydrogenated product of the polymer (α), having crystallizability

Polymer (γ): an addition polymer of a cyclic olefin monomer, having crystallizability

Polymer (δ): a hydrogenated product and the like of the polymer (γ), having crystallizability

Specifically, the alicyclic structure-containing polymer is more preferably a ring-opening polymer of dicyclopentadiene having crystallizability or a hydrogenated product of the ring-opening polymer of dicyclopentadiene having crystallizability. The alicyclic structure-containing polymer is particularly preferably the hydrogenated product of the ring-opening polymer of dicyclopentadiene having crystallizability. Herein, the ring-opening polymer of dicyclopentadiene refers to a polymer in which the ratio of a structural unit derived from dicyclopentadiene relative to all structural units is usually 50% by weight or more, preferably 70% by weight or more, more preferably 90% by weight or more, and further preferably 100% by weight.

The alicyclic structure-containing polymer having crystallizability as described above may be produced, for example, by the method described in International Publication No. 2016/067893.

In the crystallizable resin, the ratio of the alicyclic structure-containing polymer having crystallizability is preferably 50% by weight or more, more preferably 70% by weight or more, and particularly preferably 90% by weight or more. When the ratio of the alicyclic structure-containing polymer having crystallizability is equal to or more than the lower limit value of the aforementioned range, flexibility of the optical film can be enhanced. The upper limit of the ration of the alicyclic structure-containing polymer having crystallizability may be 100% by weight.

The crystallizable resin may contain an optional component in addition to the alicyclic structure-containing polymer having crystallizability. Examples of the optional components may include an antioxidant such as a phenol-based antioxidant, a phosphorus-based antioxidant, and a sulfur-based antioxidant; a light stabilizer such as a hindered amine-based light stabilizer; a wax such as a petroleum-based wax, a Fischer-Tropsch wax, and a polyalkylene wax; a nucleating agent such as a sorbitol-based compound, a metal salt of an organic phosphoric acid, a metal salt of an organic carboxylic acid, kaolin, and talc; a fluorescent brightener such as a diaminostilbene derivative, a coumarin derivative, an azole-based derivative (for example, a benzoxazole derivative, a benzotriazole derivative, a benzimidazole derivative, and a benzothiazole derivative), a carbazole derivative, a pyridine derivative, a naphthalic acid derivative, and an imidazolone derivative; an ultraviolet absorber such as a benzophenone-based ultraviolet absorber, a salicylic acid-based ultraviolet absorber, and a benzotriazole-based ultraviolet absorber; an inorganic filler such as talc, silica, calcium carbonate, and glass fiber; a colorant; a flame retardant; a flame retardant auxiliary; an antistatic agent; a plasticizer; a near-infrared absorber; a lubricant; a filler, and an optional polymer other than the alicyclic structure-containing polymer having crystallizability, such as a soft polymer. As the optional component, one type thereof may be solely used, and two or more types thereof may also be used in combination at any ratio.

The arithmetic average roughness of at least one face of the optical film of the present invention is 2.5 nm or less. When the arithmetic average roughness of at least one face of the optical film is as previously described, the advantageous effects of the present invention such as high adhesiveness and suppression of occurrence of delamination can be obtained.

The arithmetic average roughness of at least one face of the optical film is preferably 2.0 nm or less, more preferably 1.5 nm or less, and further more preferably 1.2 nm or less, and may be further smaller, which may be 0.5 nm or less. When the arithmetic average roughness of at least one face of the optical film is as previously described, the advantageous effects of the present invention such as high adhesiveness and suppression of occurrence of delamination can be easily achieved. The lower limit of the arithmetic average roughness is not particularly limited, and may be ideally 0 nm.

The optical film may be a film only either one of whose faces has the arithmetic average roughness being 2.5 nm or less. Alternatively, the optical film may be a film both of whose faces have the arithmetic average roughness being 2.5 nm or less. Also, the arithmetic average roughness may be the same or different between two faces of the optical film.

The arithmetic average roughness of the face of the optical film may be measured using a scanning probe microscope according to JIS B0601:1994. Herein, the arithmetic average roughness is the average of the absolute values of the heights (distance from an average line to a measured curve) in a reference length of a profile curve (roughness curve), which is obtained by blocking a long wavelength component through a high-pass filter with a cutoff value λc from a measured cross section curve.

The composition ratio of an oxygen element relative to a carbon element (hereinafter, also referred to as the “composition ratio of an oxygen element”) in the surface layer on the side of at least one face of the optical film of the present invention, is preferably 1/10 or more, more preferably 1/9 or more, and particularly preferably 1/8 or more, and is preferably 1/5 or less. When the composition ratio of an oxygen element in the surface layer on the side of at least one face of the optical film of the present invention falls within the above-described range, the advantageous effects of the present invention such as high adhesiveness and suppression of occurrence of delamination can be easily achieved.

In the present invention, the “surface layer” refers to a portion of the optical film from the outermost surface to a depth of 5 nm. In the present invention, the composition ratio of an element is the ratio in terms of the number of atoms. For example, when the “composition ratio of an oxygen element relative to a carbon element is 1/10”, it means that the ratio of an oxygen atom relative to 10 carbon atoms is 1.

The composition ratio of a nitrogen element relative to a carbon element (hereinafter, also referred to as the “composition ratio of a nitrogen element”) in the surface layer on the side of at least one face of the optical film of the present invention is preferably 1/20 or less, more preferably 1/30 or less, particularly preferably 1/40 or less, and further preferably ideally 0. When the composition ratio of a nitrogen element in the surface layer on the side of at least one face of the optical film of the present invention falls within the above-described range, the advantageous effects of the present invention such as high adhesiveness and suppression of occurrence of delamination can be easily achieved.

In the present invention, it is preferable that the composition ratio of an oxygen element in the surface layer on the side of at least one face of the optical film is 1/10 or more, and the composition ratio of a nitrogen element in the surface layer on the side of at least one face of the optical film is 1/20 or less.

In the present invention, when the composition ratio of an oxygen element and the composition ratio of a nitrogen element in the surface layer on the side of at least one face of the optical film fall within the above-described ranges, the arithmetic average roughness of the face can be reduced for more easily achieving the advantageous effects of the present invention such as high adhesiveness and suppression of occurrence of delamination.

When both faces of the optical film have an arithmetic average roughness of 2.5 nm or less, the composition ratio of an oxygen element and the composition ratio of a nitrogen element may fall within the above-described ranges in the surface layer on the side of either one face, or in the surface layers on the side of both faces. The composition ratios of an oxygen element and the composition ratios of a nitrogen element in the two surface layers of the optical film may be the same as or different from each other. Preferably, one face or each of both faces of the optical film satisfies the above-described requirement on the arithmetic average roughness and also satisfies the above-described requirement on the composition ratios of an oxygen element and a nitrogen element. When the optical film has a face satisfying such a plurality of requirements, favorable effects of the present invention can be obtained.

The composition ratio of an oxygen element and the composition ratio of a nitrogen element in the surface layer on a side of a face of the optical film of the present invention may be measured by X-ray photoelectron spectroscopy (XPS). Since the existence ratio of an element in a depth of several nanometers (for example, 5 nm) from a surface of a measurement sample is generally measured by the XPS method, the composition ratio of an element in the surface layer on the face of the optical film can be measured by the XPS method.

The total surface free energy on at least one face of the optical film of the present invention is preferably 60 mN/m or more, more preferably 65 mN/m or more, and particularly preferably 70 mN/m or more. The total surface free energy is ideally as high as possible. Therefore, the upper limit is not particularly limited, and may be, for example, 145 mN/m or less.

The surface free energy of a dispersive component on at least one face of the optical film of the present invention is preferably 40 mN/m or less, and more preferably 35 mN/m or less. The surface free energy of a dispersive component is ideally as low as possible. Therefore, the lower limit is not particularly limited, and may be, for example, 15 mN/m or more.

The surface free energy of a polar component on at least one face of the optical film of the present invention is preferably 20 mN/m or more, more preferably 25 mN/m or more, and particularly preferably 30 mN/m or more. The surface free energy of a polar component is ideally as high as possible. Therefore, the upper limit is not particularly limited, and may be, for example, 90 mN/m or less.

The surface free energy of a hydrogen-bond component on at least one face of the optical film of the present invention is preferably 5 mN/m or more, more preferably 8 mN/m or more, and particularly preferably 10 mN/m or more. The surface free energy of a hydrogen-bond component is ideally as high as possible. Therefore, the upper limit is not particularly limited, and may be, for example, 40 mN/m or less.

In the present invention, it is preferable that the total surface free energy is 70 mN/m or more, the surface free energy of a dispersive component is 40 mN/m or less, the surface free energy of a polar component is 25 mN/m or more, and the surface free energy of a hydrogen-bond component is 10 mN/m or more, on at least one face of the optical film. When the total surface free energy, the surface free energy of a dispersive component, the surface free energy of a polar component, and the surface free energy of a hydrogen-bond component fall within the above-described ranges on at least one face of the optical film of the present invention, the arithmetic average roughness of the face can be reduced. Accordingly, the advantageous effects of the present invention such as high adhesiveness and suppression of occurrence of delamination can be easily achieved.

When both faces of the optical film have an arithmetic average roughness of 2.5 nm or less, the optical film may be a film either one of whose faces has the total surface free energy, the surface free energy of a dispersive component, the surface free energy of a polar component, and the surface free energy of a hydrogen-bond component falling within the above-described ranges, and may alternatively be a film both of whose faces have the respective surface free energies falling within the above-described ranges. The respective surface free energies of two faces of the optical film may be the same as or different from each other. Preferably, one face or each of both faces of the optical film satisfies the above-described requirement on the arithmetic average roughness and also satisfies the above-described requirement on the surface free energy. More preferably, one face or each of both faces of the optical film satisfies the above-described requirement on the arithmetic average roughness, the above-described requirement on the composition ratios of an oxygen element and a nitrogen element, and the above-described requirement on the surface free energy. When the optical film has a face satisfying such a plurality of requirements, favorable effects of the present invention can be obtained.

The surface free energy r_{L}^{d} of a dispersive component, the surface free energy r_{L}^{P} of a polar component, and the surface free energy r_{L}^{h} of a hydrogen-bond component on the face of the optical film can be obtained by measuring the contact angle using a reagent in which the dispersive component, polar component, and hydrogen-bond component of the surface free energy are known, and calculating the surface free energy according to the extended Forkes theory formulas (the following (1) to (3) formulas).

r_{L}=r_{L}^{d}+r_{L}^{p}+r_{L}^{h} (1)

rₛ=rₛ^{d}+rₛ^{p}+rₛ^{h} (2)

r_{L}(1+cos θ)=2(rₛ^{d}·r_{L}^{d})^{1/2}+2(rₛ^{p}·r_{L}^{p})^{1/2}+2(rₛ^{h}·r_{L}^{h}))^{1/2} (3)

In the above-described formulas (1) to (3), r_{L} indicates the total surface free energy of the optical film, r_{L}^{d} indicates the surface free energy of a dispersive component of the optical film, r_{L}^{P} indicates the surface free energy of a polar component of the optical film, r_{L}^{h} indicates the surface free energy of a hydrogen-bond component of the optical film, rₛ indicates the total surface free energy of the reagent, rₛ^{d} indicates the surface free energy of a dispersive component of the reagent, rₛ^{p} indicates the surface free energy of a polar component of the reagent, rₛ^{h} indicates the surface free energy of a hydrogen-bond component of the reagent, and θ indicates the contact angle of the reagent (the same applies hereinafter).

Examples of the reagent of which the respective components of the surface free energy are known may include pure water, diiodomethane, and ethylene glycol. The total surface free energy, the surface free energy of a dispersive component, the surface free energy of a polar component, and the surface free energy of a hydrogen-bond component of these reagents are as described in Table 1 (unit: mN/m).

TABLE 1

| Reagent | rₛ | rₛ^{d} | rₛ^{p} | rₛ^{h} |
|---|---|---|---|---|
| pure water | 72.8 | 29.1 | 1.3 | 42.4 |
| diiodomethane | 50.8 | 46.8 | 4.0 | 0.0 |
| ethylene glycol | 47.7 | 30.1 | 0.0 | 17.6 |

In the present invention, the optical film preferably has a small haze. Specifically, the haze is preferably less than 3.0%, more preferably less than 2%, particularly preferably less than 1%, and ideally 0%. A film with such a small haze may be suitably used as an optical film.

The haze may be measured using a haze meter for a sample obtained by cutting the optical film around the central part of the film into a square piece of 50 mm×50 mm.

In the present invention, the optical film is usually excellent in heat resistance. Specifically, the heat resistance temperature of the optical film is usually 150° C. or higher. The optical film having such a high heat resistance temperature can be suitably used in use applications requiring heat resistance such as a resin film for vehicles, for example.

The heat resistance temperature may be measured by the following method. In a state in which tension is not applied to the optical film, the optical film is left under atmosphere of a certain evaluation temperature for 10 minutes. After that, the surface state of the optical film is visually checked. When irregularities cannot be confirmed on the surface shape of the optical film, it can be determined that the heat resistance temperature of the optical film is equal to or higher than the above-mentioned evaluation temperature.

In the present invention, it is preferable that the optical film has high total light transmittance. Specifically, the total light transmittance of the optical film is preferably 80% or more, more preferably 85% or more, and particularly preferably 88% or more. The total light transmittance thereof may be measured in the wavelength range of 400 nm to 700 nm using an ultraviolet-visible spectrometer.

Furthermore, the optical film is preferably excellent in bend resistance. The bend resistance of the optical film can be specifically represented by a bend resistance degree. The folding endurance degree is preferably 10000 times or more, more preferably 50000 times or more, and particularly preferably 100000 times or more. The folding endurance degree is preferably as high as possible. Therefore, the upper limit of the folding endurance degree is not particularly limited, and may be, for example, 1,000,000 times or less.

The bend resistance of the optical film may be measured by the following method according to a test based on the method presented in the Flexible Display Device Endurance Test Standard “IEC-62715-6-1”.

From the optical film as a sample, a test piece with a width of 15 mm±0.1 mm and a length of about 110 mm is cut out. The test piece is prepared such that a direction in which the film is stretched stronger becomes parallel to the edge of about 110 mm of the test piece. The test was performed by the method of a tension-free U-shape folding test for planar objects using a desktop endurance tester (DLDMLH-FS) manufactured by Yuasa System Co., Ltd. The bending condition was that the bend radius is 1 mm, the folding rate is 80 times/min, and the maximum number of foldings is 200,000. This folding is repeated, and the number of reciprocating foldings until the test piece is ruptured is measured.

Ten test pieces are prepared, and the number of reciprocating foldings until the test piece is ruptured is measured 10 times by the aforementioned method. The average of the thus obtained 10 measured values is adopted as the folding endurance degree (MIT folding endurance count) of the optical film.

The optical film is usually excellent in a low water absorption property. Specifically, the low water absorption property of the optical film may be represented by a water absorption rate. The water absorption rate is usually 0.1% or less, preferably 0.08% or less, and more preferably 0.05% or less.

The water absorption rate of the optical film may be measured by the following method.

From a film as a sample, a test piece is cut out, and the weight of the test piece is measured. Thereafter, this test piece is immersed in water at 23° C. for 24 hours. Then, the weight of the immersed test piece is measured. The ratio of the weight increase of the test piece due to the immersion relative to the weight of the test piece before the immersion may be calculated as a water absorption rate (%).

The remaining solvent amount in the optical film is 1.0% by weight or less, more preferably 0.5% by weight or less, and particularly preferably 0.1% by weight or less. When the remaining solvent amount is controlled to this desired value, the curl amount of the optical film can be suppressed. The remaining solvent amount may be usually obtained by gas chromatography.

The thickness of the optical film is preferably 1 μm or more, more preferably 5 μm or more, and particularly preferably 10 μm or more, and is preferably 100 μm or less, more preferably 75 μm or less, and particularly preferably 50 μm or less. When the thickness of the optical film is equal to or more than the lower limit value, the mechanical strength of the optical film can be increased. When the thickness of the optical film is equal to or less than the upper limit value, the thickness of the optical film can be reduced.

[2. Method for Producing Optical Film]

The optical film of the present invention may be produced by a production method including the following steps (3) and (4). The method for producing the optical film of the present invention may include either one or both of the following steps (1) and (2) in addition to the steps (3) and (4).

Step (1): a step of molding a crystallizable resin containing an alicyclic structure-containing polymer to obtain a crystallizable resin film having a crystallization degree of less than 3%.

Step (2): a step of stretching the crystallizable resin film containing the alicyclic structure-containing polymer.

Step (3): a step of crystallizing the crystallizable resin film containing the alicyclic structure-containing polymer to obtain a crystallized resin film.

Step (4): a plasma treatment step of performing a plasma treatment on the crystallized resin film.

[2.1. Step (1)]

The step (1) may be performed by molding a crystallizable resin containing an alicyclic structure-containing polymer by any molding method. Examples of the molding methods may include an injection molding method, a melt extrusion molding method, a press molding method, an inflation molding method, a blow molding method, a calendar molding method, a cast molding method, and a compression molding method. Among these, the melt extrusion molding method is preferable, because therewith thickness control can be easily performed.

When the crystallizable resin film is produced by the melt extrusion molding method, the conditions in the extrusion molding are preferably as follows. The cylinder temperature (melted resin temperature) is preferably Tm or higher, and more preferably (Tm+20°) C. or higher, and is preferably (Tm+100°) C. or lower, and more preferably (Tm+50°) C. or lower. The casting roll temperature is preferably (Tg−30°) C. or higher, and is preferably Tg or lower, and more preferably (Tg−15°) C. or lower. When the crystallizable resin film is produced under such conditions, the crystallizable resin film having a preferable thickness can be easily produced. Herein, “Tm” represents the melting point of the alicyclic structure-containing polymer, and “Tg” represents the glass transition temperature of the alicyclic structure-containing polymer. The crystallization degree of the crystallizable resin film obtained in the step (1) may be lower than 3%. The lower limit of the crystallization degree is not particularly limited, and may be 0% or more.

[2.2. Step (2)]

In the step (2), the crystallizable resin film is stretched.

The stretching method for the crystallizable resin film is not particularly limited, and may adopt any stretching method. Examples of the stretching method may include a uniaxial stretching method such as a method of uniaxially stretching the crystallizable resin film in a lengthwise direction (longitudinal uniaxial stretching method) and a method of uniaxially stretching the crystallizable resin film in a width direction (transversal uniaxial stretching method); a biaxial stretching method such as a simultaneous biaxial stretching method of stretching the crystallizable resin film in the width direction at the same time as stretching the crystallizable resin film in the lengthwise direction, and a sequential biaxial stretching method of stretching the crystallizable resin film in one of the lengthwise and width directions, followed by stretching the crystallizable resin film in the other direction; and a method of stretching the crystallizable resin film in an oblique direction that is not parallel to or perpendicular to the width direction thereof (oblique stretching method) such as an oblique direction of more than 0° and less than 90° relative to the width direction.

Examples of the longitudinal uniaxial stretching method may include a stretching method utilizing a difference in a peripheral speed between rolls.

Examples of the transverse uniaxial stretching method may include a stretching method using a tenter stretching machine.

Examples of the simultaneous biaxial stretching method described above may include a stretching method using a tenter stretching machine provided with a plurality of clips which are movably disposed along guide rails and can fasten the crystallizable resin film to perform stretching the crystallizable resin film in the lengthwise direction by increasing intervals between the clips and simultaneously stretching the crystallizable resin film in the width direction due to a spreading angle of the guide rail.

Examples of the sequential biaxial stretching method may include a stretching method of stretching the crystallizable resin film in the lengthwise direction utilizing a difference in peripheral speed between rolls and thereafter stretching the crystallizable resin film in the width direction using a tenter stretching machine while gripping both ends of the crystallizable resin film with clips.

Examples of the oblique stretching method may include a stretching method of continuously stretching the crystallizable resin film in the oblique direction using a tenter stretching machine which can apply, to the crystallizable resin film, a feeding force, a pulling force, or a drawing force which differs in speed between left and right sides in the lengthwise direction or in the width direction.

The stretching temperature during stretching the crystallizable resin film is preferably (Tg−30°) C. or higher, and more preferably (Tg−10°) C. or higher, and is preferably (Tg+60°) C. or lower, and more preferably (Tg+50°) C. or lower, relative to the glass transition temperature Tg of the alicyclic structure-containing polymer. When stretching is performed in such a temperature range, it is possible to properly give orientation to the polymer molecules contained in the crystallizable resin film.

The stretching ratio during stretching the crystallizable resin film may be appropriately selected depending on the desired optical properties, thickness, strength, and the like, and is usually more than 1 time, and preferably 1.01 times or more, and is usually 10 times or less, and preferably 5 times or less. Herein, when the stretching is performed in a plurality of different directions such as a case of the biaxial stretching method, the stretching ratio means a total stretching ratio represented by the product of stretching ratios in the respective stretching directions. When the stretching ratio is equal to or less than the upper limit value of the aforementioned range, a possibility of causing rupture of the film can be reduced, thereby facilitating the production of the optical film.

By subjecting the crystallizable resin film to the stretching treatment as described above, an optical film having a desired property can be obtained. Further, by performing the stretching treatment, the haze of the optical film can be reduced. Without being bound by a particular theory, it is considered that such reduction in haze is due to the fact that orientation of the molecules of the crystallizable polymer increases the speed of crystallization in the crystallization step to obtain the crystallized resin with smaller crystal nuclei.

[2.3. Step (3)]

The step (3) is a step of crystallizing a crystallizable resin film containing an alicyclic structure-containing polymer to obtain a crystallized resin film. In the step (3), the crystallizable resin film is crystallized to obtain a crystallized resin film which includes as a main component a crystallized resin having a crystallization degree of 30% or more. The crystallization may be performed within a certain temperature range in a state in which at least two edges of the crystallizable resin film are held so that the crystallizable resin film is strained.

The state in which the crystallizable resin film is strained refers to a state in which tension is applied to the crystallizable resin film. However, the state in which the crystallizable resin film is strained does not include a state in which the crystallizable resin film is substantially stretched. Being substantially stretched usually refers to that the stretching ratio of the crystallizable resin film in any one direction becomes 1.1 times or more.

When the crystallizable resin film is held, the crystallizable resin film is held by an appropriate holding tool. The holding tool may be a tool that is capable of continuously holding the entire length of the edge of the crystallizable resin film or a tool that is capable of uncontinuously holding the edges of the crystallizable resin film at intervals. For example, the edge of the crystallizable resin film may be held uncontinuously by holding tools arranged at specific intervals.

In the crystallization step, at least two edges of the crystallizable resin film are held to create a state in which the crystallizable resin film is strained. Accordingly, deformation due to heat shrinkage of the crystallizable resin film can be prevented in the region between the held edges. In order to prevent deformation in a large area of the crystallizable resin film, the crystallizable resin film is preferably held at edges including two opposite edges to keep the region between the held edges in a strained state. For example, when two opposite edges (for example, edges on the long side or edges on the short side) of a crystallizable resin film having a rectangular sheet piece shape are held to keep a region between the two edges in a strained state, it is possible to prevent deformation over the entire surface of the crystallizable resin film having the sheet piece shape. In addition, when two edges at the end in the width direction (that is, the edges on the long side) of a long-length crystallizable resin film are held to keep a region between the two edges in a strained state, it is possible to prevent deformation over the entire surface of the long-length crystallizable resin film. In the crystallizable resin film which is prevented from being deformed in this manner, occurrence of deformation such as wrinkling is prevented even if stress is generated in the film due to heat shrinkage. When the stretched film having been subjected to the stretching treatment is used as the crystallizable resin film, deformation can be prevented more reliably by holding at least two edges orthogonal to the stretching direction (in the case of biaxial stretching, the direction in which the stretching ratio is larger).

In order to more reliably prevent the deformation in the crystallization step, it is preferable to hold a larger number of edges. Therefore, for example, in the case of the crystallizable resin film in a sheet piece shape, it is preferable to hold all the edges thereof. As a specific example, in the case of a crystallizable resin film having a rectangular sheet piece shape, it is preferable to hold four edges thereof.

A preferable holding tool which can hold the edges of the crystallizable resin film may be a holding tool which does not come into contact with the crystallizable resin film at a portion other than the edges of the crystallizable resin film. When such a holding tool is used, an optical film having more excellent smoothness can be obtained.

The holding tools are preferably capable of fixing the relative positions thereof in the crystallization step. Since such holding tools do not alter the relative positions between the holding tools in the crystallization step, it is easy to prevent the crystallizable resin film from being substantially stretched in the crystallization step.

Preferable examples of the holding tools may include grippers such as clips that are provided on a frame at specific intervals as holding tools for rectangular crystallizable resin film and can grip the edges of the crystallizable resin film. Further, examples of the holding tools for holding the two edges at ends in the width-direction of the long-length crystallizable resin film may include grippers that are provided in a tenter stretching machine and can grip the edges of the crystallizable resin film.

When a long-length crystallizable resin film is used, edges at the lengthwise-direction ends (i.e., edges on the short side) of the crystallizable resin film may be held. Instead of holding the aforementioned edges, the both sides of a region subjected to a crystallization treatment in the lengthwise direction of the crystallizable resin film may be held. For example, on both sides in the lengthwise direction of a region subjected to a crystallization treatment of the crystallizable resin film, a holding device that can hold the crystallizable resin film to be in a strained state so as to prevent occurrence of heat shrinkage may be provided. Examples of such a holding device may include a combination of two rolls and a combination of an extruder and a drawing roll. When a tension such as feeding tension is applied to the crystallizable resin film with the use of such a combination, it is possible to prevent heat shrinkage of the crystallizable resin film in a region subjected to a crystallization treatment. Therefore, when such a combination is used as the holding device, the crystallizable resin film can be held while being fed in the lengthwise direction, which makes it possible to efficiently produce the optical film.

In the crystallization step, the crystallizable resin film is brought to a temperature higher than or equal to the glass transition temperature Tg of the alicyclic structure-containing polymer and lower than or equal to the melting point Tm of the alicyclic structure-containing polymer in a state in which at least two edges of the crystallizable resin film are held so that the crystallizable film is strained as described above. In the crystallizable resin film brought to the aforementioned temperature, crystallization of the alicyclic structure-containing polymer proceeds. Thus, by this crystallization step, a crystallized resin film containing a crystallized alicyclic structure-containing polymer is obtained. At this time, since the crystallized resin film is kept in a strained state while preventing deformation of the crystallized resin film, crystallization can be promoted without impairing the smoothness of the crystallized resin film.

As described above, the temperature range in the crystallization step may be optionally set within a temperature range of the glass transition temperature Tg of the alicyclic structure-containing polymer or higher and the melting point Tm of the alicyclic structure-containing polymer or lower. Among these, it is preferable to set the temperature so as to increase the speed of crystallization. The temperature of the crystallizable resin film in the crystallization step is preferably (Tg+20°) C. or higher, and more preferably (Tg+30°) C. or higher, and is preferably (Tm−20°) C. or lower, and more preferably (Tm−40°) C. or lower. When the temperature in the crystallization step is equal to or lower than the upper limit of the above-mentioned range, clouding of the optical film can be prevented, and thus an optical film suitable for the case where an optically transparent film is required can be obtained.

When the crystallizable resin film is brought to the above-mentioned temperature, heating of the crystallizable resin film is usually performed. As the heating device used at this time, a heating device capable of raising the atmosphere temperature of the crystallizable resin film is preferable since such a heating device does not require contact between the heating device and the crystallizable resin film. Specific examples of suitable heating devices may include an oven and a heating furnace.

In the crystallization step, the treatment time during which the crystallizable resin film is maintained in the above-mentioned temperature range is preferably 1 second or more, and more preferably 5 seconds or more, and is preferably 30 minutes or less, and more preferably 10 minutes or less. When the crystallization of the alicyclic structure-containing polymer is sufficiently promoted in the crystallization step, the flexibility of the optical film can be enhanced. In addition, when the processing time is equal to or less than the upper limit of the above-mentioned range, clouding of the optical film can be prevented, and thus an optical film suitable for a case where an optically transparent film is required can be obtained.

[2.4. Step (4)]

In the step (4), the crystallized resin film is subjected to a plasma treatment (plasma treatment step).

Regarding the optical film using the prior-art crystallized resin, it was presumed that one of the reason for the high tendency of occurrence of delamination was that a fragile layer was formed on the surface of the crystallized resin film.

When the crystallized resin film is subjected to a plasma treatment in the step (4), the fragile layer can be removed and the arithmetic average roughness of the face can be reduced, and as a result, a crystallized resin film having an arithmetic average roughness of at least one face of 2.5 nm or less can be easily obtained.

The plasma treatment step may be performed under atmospheric pressure or vacuum, but from the viewpoint of productivity, the plasma treatment step is preferably performed under atmospheric pressure. The plasma treatment under atmospheric pressure may be performed using, for example, an atmospheric pressure plasma surface treatment apparatus (product name “RD640”, manufactured by Sekisui Chemical Co., Ltd.).

The plasma treatment step is preferably performed under gas atmosphere containing one or more gases selected from hydrogen gas, helium gas, nitrogen gas, oxygen gas, carbon dioxide gas, and argon gas, and more preferably under a gas atmosphere containing nitrogen gas and one or more gases selected from oxygen gas and carbon dioxide gas.

In the step (4), the crystallized resin film is preferably subjected to a plasma treatment in a gas atmosphere containing nitrogen gas and one or more gasses selected from oxygen gas and carbon dioxide gas such that the weight ratio of oxygen relative to nitrogen is 5.50×10⁻³ or more and 1.30×10⁻¹ or less.

When nitrogen gas and oxygen gas are used, the plasma treatment is preferably performed in a gas atmosphere containing nitrogen gas and oxygen gas such that the weight ratio of oxygen relative to nitrogen is 5.50×10⁻³ or more and 3.50×10⁻² or less, more preferably, the plasma treatment is performed in a gas atmosphere containing these gasses such that the ratio is 8.0×10⁻³ or more and 1.5×10⁻² or less. When the plasma treatment step is performed in a gas atmosphere containing nitrogen gas and oxygen gas in the above-described weight ratio, it becomes easier to make the arithmetic average roughness of the face of the crystallized resin film 2.5 nm or less.

When nitrogen gas and carbon dioxide gas are used, the plasma treatment is preferably performed in a gas atmosphere containing nitrogen gas and carbon dioxide gas such that the weight ratio of oxygen relative to nitrogen is 2.50×10⁻² or more and 1.30×10⁻¹ or less, more preferably, the plasma treatment is performed in a gas atmosphere containing these gasses such that the ratio is 3.5×10⁻² or more and 1.0×10⁻¹ or less. When the plasma treatment step is performed in a gas atmosphere containing nitrogen gas and carbon dioxide gas in the above-described weight ratio, it becomes easier to make the arithmetic average roughness of the face of the crystallized resin film 2.5 nm or less.

When nitrogen gas and oxygen gas or carbon dioxide gas are used, the flow rate of the nitrogen gas is preferably 5 to 15 NL/min, and the flow rate of the carbon dioxide gas or oxygen gas is preferably 0.025 to 0.15 NL/min. The output of the plasma irradiation is preferably 500 to 3000 W. It is preferable that the frequency of the plasma irradiation is a resonance frequency corresponding to the output, and specifically, it is preferable that the frequency is in the range of 25 to 100 KHz. The irradiation rate of the plasma irradiation is preferably 50 to 500 cm/min. The distance between the plasma source and the surface to be treated is preferably 0.5 to 3 mm.

When plasma irradiation is performed under reduced pressure instead of normal pressure, the plasma treatment is preferably performed using a low-pressure gas (such as argon gas, oxygen gas, nitrogen gas, or a mixed gas thereof) of 0.001 to 10 kPa (absolute pressure). As the low-pressure gas, a mixed gas of nitrogen and oxygen is particularly preferably used. The mixing ratio of nitrogen and oxygen is preferably 10:1 to 1:10 by volume, and the flow rate of the mixed gas is preferably 0.1 to 10 NL/min. The output of the plasma irradiation is preferably 50 to 3000 W.

[2.5. Other Steps]

In the production method of the present invention, an optional step may be performed in addition to the above-described steps.

As an example of such an optional step, after the step (1), the surface of the crystallizable resin film may be subjected to a modification treatment. Examples of the treatment for modifying the surface of the crystallizable resin film may include a corona discharge treatment, a plasma treatment, a saponification treatment, and an ultraviolet irradiation treatment. Of these, a corona discharge treatment and a plasma treatment are preferable from the viewpoint of the treatment efficiency and the like, and a plasma treatment is more preferable.

As another example of such an optional step, after the step (3), a relaxation step in which the crystallized resin film is thermally shrunk to remove residual stress may be performed.

[3. Optional Layer]

The optical film of the present invention may include an optional layer. Examples of the optional layer may include an easy-adhesion layer, an electroconductive layer, an antireflective layer, a hard coat layer, an antistatic layer, an anti-glare layer, an anti-fouling layer, and a separator film.

[4. Multilayer Film]

The multilayer film of the present invention comprises an optical film, an adherend layer, and an adhesive layer provided between the optical film and the adherend layer. The multilayer film is a layered body in which the optical film and the adherend layer are layered with an adhesive agent interposed therebetween.

As the adhesive agent constituting the adhesive layer, various adhesive agents capable of achieving satisfactory adhesion with the layer of urethane resin may be used. Specific examples may include an ultraviolet curable acrylic composition, an ultraviolet curable epoxy composition, and an ultraviolet curable polymerization composition in which an acrylic monomer and an epoxy monomer are mixed.

The adherend layer may be a member which can be used as a component of a display device, and may be any member which can easily achieve adhesion by the adhesive layer. Specifically, the adherend layer may be a layer of an inorganic material such as a glass plate and a metal plate, or a layer of a resin. Examples of the material constituting the layer of a resin may include an amorphous alicyclic structure-containing polymer resin, a resin containing polyvinyl alcohol as a main component constituting a polarizer of a polarizing plate, a cellulose-based resin constituting a polarizing plate protective film, a crystallizable alicyclic structure-containing polymer resin, and a crystallizable polyester-based resin.

The multilayer film of the present invention may be produced by bonding a face having an arithmetic average roughness of 2.5 nm or less of the faces of the optical film of the present invention and an adherend layer via an adhesive agent. Specifically, the production of the multilayer film may be achieved by applying an adhesive agent onto a face of the optical film of the present invention having an arithmetic average roughness of 2.5 nm or less, attaching the face on one face of the adherend layer, and further curing the adhesive agent as necessary. When both faces of the optical film are faces having an arithmetic average roughness of 2.5 nm or less, a multilayer film may be produced by applying an adhesive agent onto either one or both faces of the optical film, and attaching thereto the adherend layer to effect bonding, to thereby produce the multilayer film.

The multilayer film of the present invention has properties such as high heat resistance and flexibility derived from the optical film formed of a crystallized resin. According to the present invention, by setting the arithmetic average roughness of at least one face of the optical film to 2.5 nm or less, it is possible to provide a multilayer film having high adhesiveness and high peel strength with respect to the adherend layer with an adhesive agent interposed therebetween, and as a result, it is possible to provide a multilayer film having little tendency of occurrence of interlayer peeling and high durability.

[5. Use Application]

The optical film and the multilayer film of the present invention may be used in any use applications. It may be used particularly usefully as a touch sensor which is a component of a touch panel by taking advantage of the property of low tendency to cause delamination.

### EXAMPLES

Hereinafter, the present invention will be specifically described by illustrating Examples. However, the present invention is not limited to the Examples described below. The present invention may be optionally modified for implementation without departing from the scope of claims of the present invention and its equivalents.

In the following description, “%” and “part” representing quantity are on the basis of weight, unless otherwise specified. The operations described below were performed under the conditions of normal temperature and normal pressure, unless otherwise specified.

<Evaluation Method>

(Measurement Method of Thickness) The thickness of each layer constituting the optical film and the multilayer film was measured in the following manner. The refractive index of each layer of a film as a sample was measured using an ellipsometry (“M-2000” manufactured by J.A. Woollam Co.). Thereafter, with the measured refractive index, the thickness of the film was measured by a light interference film thickness meter (“MCPD-9800” manufactured by Otsuka Electronics Co., Ltd.).

(Weight-Average Molecular Weight and Number-Average Molecular Weight)

The weight-average molecular weight and the number-average molecular weight of the polymer were measured as a polystyrene-equivalent value using a gel permeation chromatography (GPC) system (“HLC-8320” manufactured by Tosoh Corporation). In the measurement, an H-type column (manufactured by Tosoh Corporation) was used as a column, and tetrahydrofuran was used as a solvent. The temperature during the measurement was 40° C.

(Glass Transition Temperature Tg, Melting Point Tm, and Crystallization Temperature Tpc of Crystallizable Resin)

A sample heated to 300° C. under nitrogen atmosphere was quenched with liquid nitrogen. A differential scanning calorimeter (DSC) was used to increase the temperature at 10° C./min. Then, the glass transition temperature Tg, melting point Tm, and crystallization temperature Tpc of the sample were each calculated.

(Measurement Method of Hydrogenation Rate of Polymer)

The hydrogenation rate of the polymer was measured by ¹H-NMR measurement at 145° C. with ortho-dichlorobenzene-d⁴ as a solvent.

(Racemo Diad Ratio of Polymer)

¹³C-NMR measurement of the polymer was performed at 200° C. with ortho-dichlorobenzene-d⁴ as a solvent by an inverse-gated decoupling method. From the result of the ¹³C-NMR measurement, a signal attributable to a meso⋅diad at 43.35 ppm and a signal attributable to a racemo⋅diad at 43.43 ppm were identified with a peak of ortho-dichlorobenzene-d⁴ at 127.5 ppm as a reference shift. On the basis of the intensity ratio of these signals, the racemo diad ratio of the polymer was obtained.

(Crystallization Degree)

The crystallization degree was confirmed by the X-ray diffraction according to JIS K0131. Specifically, a wide-angle X-ray diffraction device (RINT 2000 manufactured by Rigaku Corporation) was used to obtain an intensity of diffracted X-ray from a crystallized part, and the crystallization degree was calculated from the ratio relative to the intensity of entire diffracted X-ray, according to the following formula (I).

Xc=K·Ic/It (I)

In the above-described formula (I), Xc represents the crystallization degree of the test sample, Ic represents the intensity of diffracted X-ray from the crystallized part, It represents the intensity of entire diffracted X-ray, and K represents a correction term.

(Heat Resistant Temperature)

In a state in which tension was not applied to the optical film, the optical film was left under the atmosphere at a certain constant evaluation temperature for 10 minutes. Thereafter, the state of the surface of the optical film was visually observed. The evaluation temperature was set from 150° C. to a temperature at which an irregularities portion was confirmed on the surface of the optical film, in increments of 10° C. The highest temperature among the evaluation temperatures at which an irregularities portion was not confirmed on the surface of the optical film was defined as the heat resistant temperature of the optical film.

(Bend Resistance)

The bend resistance of the optical film was measured by the following method according to a test based on the method presented in the Flexible Display Device Endurance Test Standard “IEC 62715-6-1”.

From the optical film as a sample, a test piece with a width of 15 mm±0.1 mm and a length of about 110 mm was cut out. The test piece was prepared such that a direction in which the film was stretched stronger became parallel to the edge of about 110 mm of the test piece. The test was performed by a tension-free U-shape folding test method for planar objects using a desktop endurance tester (DLDMLH-FS) manufactured by Yuasa System Co., Ltd. The bending condition was that the bend radius is 1 mm, the folding rate was 80 times/min, and the maximum number of foldings was 200,000. This folding was repeated until the test piece was ruptured, and the number of reciprocating foldings when the test piece was ruptured was measured.

Ten test pieces were prepared, and the number of reciprocating foldings until the test piece was ruptured was measured 10 times by the aforementioned method. The average of the 10 measured values was adopted as the bend resistance (MIT folding endurance count) of the optical film.

(Measurement Method of Arithmetic Average Roughness)

The arithmetic average roughness Ra of two faces of the optical film was measured using a scanning probe microscope (Dimension Icon manufactured by Bruker AX GmbH) according to JIS B 0601:1994.

(Measurement of Elemental Composition Ratio in Surface Layer)

The composition ratio of an oxygen element and the composition ratio of a nitrogen element in the surface layer on the face of the optical film was measured using an XPS measuring and analyzing device (“PHI 5000 VersaProbe III”, manufactured by Ulvac-Phi, Inc.).

(Measurement of Surface Free Energy)

The optical film was cut out into a size of about 10 cm square to obtain a substrate piece. On a face of this substrate piece, the contact angle of pure water (H₂O), the contact angle of diiodomethane (CH₂I₂), and the contact angle of ethylene glycol were actually measured using an automatic contact angle meter. From the contact angle data measured in this manner, the surface free energies (the total surface free energy, the surface free energy of a dispersive component, the surface free energy of a polar component, and the surface free energy of a hydrogen-bond component) on the face of the substrate were calculated by a software attached to the contact angle meter. The condition in the measurement is as follows.

Contact Angle Measurement Condition

System: Drop Master 700 (manufactured by Kyowa Interface Science Co., Ltd.)

Auto Dispenser AD-31 (manufactured by Kyowa Interface Science Co., Ltd.)

Control analysis software: FAMAS ver 3.13

Contact angle measurement method: hanging drop method

Visual field: STD

Analysis method: Young-Laplace method

Teflon (registered trademark) coated needle: 18G (or 22G)

Liquid amount: 3 μL to 4 μL

Measurement waiting time: 3000 ms

Measurement number: n=10 measurements, average value

Calculation Method of Surface Free Energy

Analysis software: FAMAS ver 3.13

Analysis theory name: Owens-Wendt

(Measurement Method of Peel Strength)

The multilayer film obtained in each of Examples and Comparative Examples was cut to have a width of 25 mm. The face on the optical film side was bonded to the surface of a slide glass via an adhesive agent. In the bonding, a both-face adhesive tape (manufactured by Nitto Denko Corporation, product no. “CS9621”) was used as the adhesive agent. After the bonding, the bonded product was left to stand for 12 hours.

Thereafter, the end of the adherend layer was pinched by a jig disposed at the tip of a force gauge, and pulled in the normal line direction of the surface of the slide glass, thereby to perform a 90 degree peeling test. In the pulling, the peeling speed was 20 mm/min. Since the force measured when the adherend layer was peeled is a force necessary to peel the adherend layer from the optical film, the magnitude of this force was measured as peel strength.

### Production Example 1. Production of Hydrogenated Product of Ring-Opening Polymer of Dicyclopentadiene

A metal pressure resistant reaction vessel was sufficiently dried. Then the atmosphere in the vessel was substituted with nitrogen. Into this metal pressure resistant reaction vessel, 154.5 parts of cyclohexane, 42.8 parts (30 parts as the amount of dicyclopentadiene) of a 70% cyclohexane solution of dicyclopentadiene (endo-form containing rate: 99% or more), and 1.9 parts of 1-hexene were added, and heated to 53° C.

Into a solution in which 0.014 part of a tetrachlorotungsten phenylimide (tetrahydrofuran) complex was dissolved in 0.70 part of toluene, 0.061 part of a 19% diethylaluminum ethoxide/n-hexane solution was added. The resultant solution was stirred for 10 minutes to prepare a catalyst solution.

This catalyst solution was added into the pressure resistant reaction vessel to initiate a ring-opening polymerization reaction. Thereafter, the reaction continued for 4 hours while the temperature was maintained at 53° C. Thus, a solution of a ring-opening polymer of dicyclopentadiene was obtained.

The number-average molecular weight (Mn) and the weight-average molecular weight (Mw) of the obtained ring-opening polymer of dicyclopentadiene were 8750 and 28,100, respectively. The molecular weight distribution (Mw/Mn) calculated from these values was 3.21.

To 200 parts of the obtained solution of the ring-opening polymer of dicyclopentadiene, 0.037 part of 1,2-ethanediol was added as a terminator. The solution was heated to 60° C., and stirred for 1 hour to terminate the polymerization reaction. To this product, 1 part of a hydrotalcite-like compound (“Kyoward (registered trademark) 2000” manufactured by Kyowa Chemical Industry Co., Ltd.) was added. The mixture was heated to 60° C., and stirred for 1 hour. Thereafter, 0.4 part of a filter aid (“Radiolite (registered trademark) #1500” manufactured by Showa Chemical Industry Co., Ltd.) was added, and the adsorbent and the solution were separated by filtering through a PP pleated cartridge filter (“TCP-HX” manufactured by Advantec Toyo Kaisha Ltd.).

To 200 parts (polymer amount: 30 parts) of the solution of the ring-opening polymer of dicyclopentadiene after filtering, 100 parts of cyclohexane was added. Then, 0.0043 part of chlorohydridocarbonyl tris(triphenylphosphine) ruthenium was added. Then, a hydrogenation reaction was performed at a hydrogen pressure of 6 MPa and a temperature of 180° C. for 4 hours. Accordingly, a reaction solution containing a hydrogenated product of the ring-opening polymer of dicyclopentadiene was obtained. The hydrogenated product had been deposited, and the reaction solution had become a slurry solution.

The hydrogenated product contained in the aforementioned reaction solution was separated from the solution using a centrifugal separator. Then, drying was performed under reduced pressure at 60° C. for 24 hours to obtain 28.5 parts of the hydrogenated product of the ring-opening polymer of dicyclopentadiene having crystallizability. This hydrogenated product had a hydrogenation rate of 99% or more, a glass transition temperature Tg of 94° C., a melting point (Tm) of 262° C., a crystallization temperature Tpc of 170° C., and a racemo diad ratio of 89%.

### Example 1

(1-1. Production of Crystallizable Resin Film Having Crystallization Degree of Less than 3%)

To 100 parts of the hydrogenated product of the ring-opening polymer of dicyclopentadiene obtained in Production Example 1, 0.5 part of an antioxidant (tetrakis[methylene-3-(3′,5′-di-t-butyl-4′-hydroxyphenyl)propionate]methane; “Irganox (registered trademark) 1010” manufactured by BASF Japan Ltd.) was mixed to obtain a crystallizable resin as a material of the optical film. Hereinafter, this crystallizable resin is also referred to as a “resin A”.

The resin A was poured into a twin-screw extruder (“TEM-37B” manufactured by Toshiba Machine Co. Ltd.) having four die holes each having an inner diameter of 3 mmϕ. With the twin screw extruder, the resin was molded into a strand-shape molded article by hot melt extrusion molding. This molded article was shredded with a strand cutter to obtain pellets of the crystallizable resin.

Subsequently, the obtained pellets were supplied to a hot-melt extrusion film molding machine provided with a T die. With this film molding machine, a long-length film (width 120 mm) formed of the resin A was produced by a method of winding up into a roll at a speed of 27 m/min. The operation condition of the film molding machine is as follows.
Barrel set temperature: 280° C. to 290° C.
Die temperature: 270° C.
Screw rotation speed: 30 rpm
Casting roll temperature: 70° C.

Accordingly, a long-length crystallizable resin film was obtained. The thickness of the obtained film was 20 μm. The crystallization degree of the crystallizable resin in this film was 0.7%.

(1-2. Stretching Step)

The long-length crystallizable resin film obtained in (1-1) was cut out into a square of 350 mm×350 mm. This cutting out was performed such that the respective edges of the cut-out square of the crystallizable resin film were parallel to the lengthwise direction or the width direction of the long-length crystallizable resin film. The cut-out crystallizable resin film was mounted on a compact stretching machine (“EX10-B type” manufactured by Toyo Seiki Seisaku-sho, Ltd.). This compact stretching machine is equipped with a plurality of clips which can grip four edges of the film. This compact stretching machine has a structure which enables stretching of the film by the movement of the clips.

The oven temperature of the compact stretching machine was set at 130° C., and the crystallizable resin film was stretched in a direction corresponding to the lengthwise direction of the long-length crystallizable resin film with a stretching ratio of 1.2 times, at a stretch temperature of 130° C. and a stretch speed of 4.0 mm/min. Accordingly, a stretched crystallizable resin film was obtained.

(1-3. Production of Crystallized Resin Film)

The crystallizable resin film stretched in (1-2) was subjected to a heat treatment while being mounted on the compact stretching machine. The heat treatment was performed in such a manner that secondary heat plates attached to the compact stretching machine were brought into proximity to the upper face and the lower face of the crystallizable resin film while four edges of the crystallizable resin film were held, and this state was maintained for 30 seconds. In this heat treatment, the temperature of the secondary heat plates was 170° C., and the distances upward and downward from the film to the secondary heat plates were each 8 mm. This promoted the crystallization of the crystallizable resin in the crystallizable resin film. Accordingly, a crystallized resin film was obtained.

The crystallization degree of the crystallized resin in the obtained crystallized resin film was 71%.

(1-4. Production of Optical Film)

One face of the crystallized resin film obtained in (1-3) was subjected to a plasma treatment under gas atmosphere containing nitrogen gas and oxygen gas at 99.5:0.5 (% by weight), using an atmospheric-pressure plasma surface treatment apparatus (product name “RD640”, manufactured by Sekisui Chemical Co., Ltd.) to obtain an optical film. The condition of the plasma treatment was an output of 1000 w, a voltage of 450 V, an electric current of 0.65 A, a frequency of 60 kHz, an irradiation rate of 300 cm/min, an irradiation time of 6 seconds, and a distance between a plasma source and a surface to be treated of 1 mm. The arithmetic average roughness (Ra), the elemental composition ratio of the surface layer, and the respective surface energies were measured for the plasma treated surface of the obtained optical film. The average of the measured values was calculated.

(1-5. Multilayer Film)

As an adherend layer, a resin film comprising a norbornene-based polymer (trade name “ZEONOR Film ZF16-100”, glass transition temperature 160° C., thickness 100 μm, unstretched, manufactured by ZEON Corporation) was prepared.

One face of the resin film was subjected to a corona treatment. In the corona treatment, a corona treatment apparatus manufactured by Kasuga Denki, Inc. was used, and the treatment condition was a discharge amount of 150 W/m²/min in the atmospheric air.

Onto the corona treated surface of the resin film, an ultraviolet curable adhesive agent (CRB1352 manufactured by Toyo Ink Co., Ltd.) was applied. The surface was then bonded to the plasma treated surface of the optical film produced in (1-4) using a laminator.

The bonded product was irradiated with ultraviolet rays using a high pressure mercury lamp, under the condition of an illuminance of 350 mW/cm² and an integrated light quantity of 1000 mJ/cm². Accordingly, the adhesive agent was crosslinked to become an adhesive layer.

Accordingly, there was obtained a multilayer film which includes a layer of the crystallized resin as an optical film, an adhesive layer, and a layer of a resin film (adherend layer) in this order. The peel strength of the obtained multilayer film was measured.

### Example 2

(2-4. Production of Optical Film)

An optical film was obtained by the same manner as that in (1-1) to (1-4) of Example 1 except that, in (1-4) of Example 1, the gas atmosphere for the plasma treatment was changed to a gas atmosphere containing nitrogen gas and oxygen gas at 99.0:1.0 (% by weight). The arithmetic average roughness (Ra), the elemental composition ratio of the surface layer, and the respective surface energies were measured for the obtained optical film.

(2-5. Multilayer Film)

A multilayer film was obtained by the same manner as that in Example 1 except that, in (1-5) of Example 1, the optical film produced in (2-4) was used instead of the optical film produced in (1-4). The peel strength of the obtained multilayer film was measured.

### Example 3

(3-4. Production of Optical Film)

An optical film was obtained by the same manner as that in (1-1) to (1-4) of Example 1 except that, in (1-4) of Example 1, the gas atmosphere for the plasma treatment was changed to a gas atmosphere containing nitrogen gas and oxygen gas at 98.0:2.0 (% by weight). The arithmetic average roughness (Ra), the elemental composition ratio of the surface layer, and the respective surface energies were measured for the obtained optical film.

(3-5. Multilayer Film)

A multilayer film was obtained by the same manner as that in Example 1 except that, in (1-5) of Example 1, the optical film produced in (3-4) was used instead of the optical film produced in (1-4). The peel strength of the obtained multilayer film was measured.

### Example 4

(4-4. Production of Optical Film)

An optical film was obtained by the same manner as that in (1-1) to (1-4) of Example 1 except that, in (1-4) of Example 1, the gas atmosphere for the plasma treatment was changed to a gas atmosphere containing nitrogen gas and carbon dioxide gas at 97.0:3.0 (% by weight). The arithmetic average roughness (Ra), the elemental composition ratio of the surface layer, and the respective surface energies were measured for the obtained optical film.

(4-5. Multilayer Film)

A multilayer film was obtained by the same manner as that in Example 1 except that, in (1-5) of Example 1, the optical film produced in (4-4) was used instead of the optical film produced in (1-4). The peel strength of the obtained multilayer film was measured.

### Example 5

(5-4. Production of Optical Film)

An optical film was obtained by the same manner as that in (1-1) to (1-4) of Example 1 except that, in (1-4) of Example 1, the gas atmosphere for the plasma treatment was changed to a gas atmosphere containing nitrogen gas and carbon dioxide gas at 95.0:5.0 (% by weight). The arithmetic average roughness (Ra), the elemental composition ratio of the surface layer, and the respective surface energies were measured for the obtained optical film.

(5-5. Multilayer Film)

A multilayer film was obtained by the same manner as that in Example 1 except that, in (1-5) of Example 1, the optical film produced in (5-4) was used instead of the optical film produced in (1-4). The peel strength of the obtained multilayer film was measured.

### Example 6

(6-4. Production of Optical Film)

An optical film was obtained by the same manner as that in (1-1) to (1-4) of Example 1 except that, in (1-4) of Example 1, the gas atmosphere for the plasma treatment was changed to a gas atmosphere containing nitrogen gas and carbon dioxide gas at 90.0:10.0 (% by weight). The arithmetic average roughness (Ra), the elemental composition ratio of the surface layer, and the respective surface energies were measured for the obtained optical film.

(6-5. Multilayer Film)

A multilayer film was obtained by the same manner as that in Example 1 except that, in (1-5) of Example 1, the optical film produced in (6-4) was used instead of the optical film produced in (1-4). The peel strength of the obtained multilayer film was measured.

### Comparative Example 1

A multilayer film was obtained by the same manner as that in Example 1 except that, in (1-5) of Example 1, the crystallized resin film (crystallized resin film before plasma treatment) produced in (1-3) was used instead of the optical film produced in (1-4). The peel strength of the obtained multilayer film was measured.

In Comparative Example 1, since the crystallized resin film in (1-3) of Example 1 was used for the production of the multilayer film, the arithmetic average roughness (Ra), the elemental composition ratio of the surface layer, and the surface free energies were measured for the crystallized resin film produced in (1-3) of Example 1.

### Comparative Example 2

(C2-4. Production of Optical Film)

An optical film was obtained by the same manner as that in (1-1) to (1-4) of Example 1 except that, in (1-4) of Example 1, the gas atmosphere for the plasma treatment was changed to a nitrogen gas atmosphere (containing 100% nitrogen gas). The arithmetic average roughness (Ra), the elemental composition ratio of the surface layer, and the respective surface energies were measured for the obtained optical film.

(C2-5. Multilayer Film)

A multilayer film was obtained by the same manner as that in (1-5) of Example 1 except that, in (1-5) of Example 1, the optical film produced in (C2-4) was used instead of the optical film produced in (1-4). The peel strength of the obtained multilayer film was measured.

### Comparative Example 3

(C3-4. Production of Optical Film)

An optical film was obtained by the same manner as that in (1-1) to (1-4) of Example 1 except that, in (1-4) of Example 1, the gas atmosphere for the plasma treatment was changed to a gas atmosphere containing nitrogen gas and oxygen gas at 99.9:0.1 (% by weight). The arithmetic average roughness (Ra), the elemental composition ratio of the surface layer, and the respective surface energies were measured for the obtained optical film.

(C3-5. Multilayer Film)

A multilayer film was obtained by the same manner as that in (1-5) of Example 1 except that, in (1-5) of Example 1, the optical film produced in (C3-4) was used instead of the optical film produced in (1-4). The peel strength of the obtained multilayer film was measured.

### Comparative Example 4

(C4-4. Production of Optical Film)

An optical film was obtained by the same manner as that in (1-1) to (1-4) of Example 1 except that, in (1-4) of Example 1, the gas atmosphere for the plasma treatment was changed to a gas atmosphere containing nitrogen gas and oxygen gas at 97.0:3.0 (% by weight). The arithmetic average roughness (Ra), the elemental composition ratio of the surface layer, and the respective surface energies were measured for the obtained optical film.

(C4-5. Multilayer Film)

A multilayer film was obtained by the same manner as that in (1-5) of Example 1 except that, in (1-5) of Example 1, the optical film produced in (C4-4) was used instead of the optical film produced in (1-4). The peel strength of the obtained multilayer film was measured.

### Comparative Example 5

(C5-4. Production of Optical Film)

An optical film was obtained by the same manner as that in (1-1) to (1-4) of Example 1 except that, in (1-4) of Example 1, the gas atmosphere for the plasma treatment was changed to a gas atmosphere containing nitrogen gas and carbon dioxide gas at 98.0:2.0 (% by weight). The arithmetic average roughness (Ra), the elemental composition ratio of the surface layer, and the respective surface energies were measured for the obtained optical film.

(C5-5. Multilayer Film)

A multilayer film was obtained by the same manner as that in (1-5) of Example 1 except that, in (1-5) of Example 1, the optical film produced in (C5-4) was used instead of the optical film produced in (1-4). The peel strength of the obtained multilayer film was measured.

### Comparative Example 6

(C6-4. Production of Optical Film)

An optical film was obtained by the same manner as that in (1-1) to (1-4) of Example 1 except that, in (1-4) of Example 1, the gas atmosphere for the plasma treatment was changed to a gas atmosphere containing nitrogen gas and carbon dioxide gas at 85.0:15.0 (% by weight). The arithmetic average roughness (Ra), the elemental composition ratio of the surface layer, and the respective surface energies were measured for the obtained optical film.

(C6-5. Multilayer Film)

A multilayer film was obtained by the same manner as that in (1-5) of Example 1 except that, in (1-5) of Example 1, the optical film produced in (C6-4) was used instead of the optical film produced in (1-4). The peel strength of the obtained multilayer film was measured.

### Comparative Example 7

(C7-4. Production of Optical Film)

One face of the crystallized film produced in (1-3) of Example 1 was irradiated with excimer light (wavelength: 175 nm) for 6 seconds with the focal length of 3 mm in the air using an excimer lamp (EX-mini L12530-01, manufactured by Hamamatsu Photonics Co., Ltd.) to obtain an optical film.

The arithmetic average roughness (Ra), the elemental composition ratio of the surface layer, and the respective surface energies were measured for the obtained optical film.

(C7-5. Multilayer Film)

A multilayer film was obtained by the same manner as that in (1-5) of Example 1 except that, in (1-5) of Example 1, the optical film produced in (C7-4) was used instead of the optical film produced in (1-4). The peel strength of the obtained multilayer film was measured.

### Comparative Example 8

(C8-4. Production of Optical Film)

A stretched film was obtained by the same manner as that in (1-1) to (1-2) of Example 1 using pellets of an amorphous norbornene resin (trade name “ZEONOR 1600” manufactured by ZEON Corporation, with Tg of 163° C. and refractive index of 1.53; hereinafter referred to as “resin B”) instead of the resin A in (1-1) of Example 1. One face of the obtained film was subjected to a plasma treatment under the same conditions as that in (5-4) of Example 5 to obtain an optical film. The arithmetic average roughness (Ra), the elemental composition ratio of the surface layer, and the respective surface energies were measured for the obtained optical film.

(C8-5. Multilayer Film)

A multilayer film was obtained by the same manner as that in Example 1 except that, in (1-5) of Example 1, the optical film produced in (C8-4) was used instead of the optical film produced in (1-4). The peel strength of the obtained multilayer film was measured.

<Results>

The results of Examples and Comparative Examples are shown in Table 2 and Table 3.

Tables 2 and 3 show the type of resin and the plasma treatment condition (a gas ratio (% by weight) and a weight ratio of oxygen to nitrogen) for Examples and Comparative Examples.

In Table 2, the “arithmetic average roughness of plasma treated face” means the “arithmetic average roughness of a face having been subjected to a plasma treatment, of two faces of the optical film”, and the “arithmetic average roughness of untreated face” means the “arithmetic average roughness of a face not having been subjected to a plasma treatment, of two faces of the optical film”.

In Table 3, the “arithmetic average roughness of treated face” means the “arithmetic average roughness of a face having been subjected to a plasma treatment or an excimer treatment, of two faces of the optical film”, and the “arithmetic average roughness of untreated face” means the “arithmetic average roughness of a face not having been subjected to a plasma treatment or an excimer treatment, of two faces of the optical film”. In Comparative Example 1, both faces of the optical film were not subjected to a surface treatment. Therefore, the arithmetic average roughnesses of two faces are illustrated in the “untreated face”. In Table 3, the “both faces 3.0” means that the arithmetic average roughnesses for both faces of the optical film are 3.0 nm.

TABLE 2

| | | | Example | | | | | |
|---|---|---|---|---|---|---|---|---|
| | | | 1 | 2 | 3 | 4 | 5 | 6 |
| type of resin | | | A | A | A | A | A | A |
| plasma | gas ratio | N₂ | 99.5 | 99 | 98 | 97 | 95 | 90 |
| treatment | (% by | O₂ | 0.5 | 1 | 2 | 0 | 0 | 0 |
| condition | weight) | CO₂ | 0 | 0 | 0 | 3 | 5 | 10 |
| | weight ratio (O/N)(×10⁻³) | | 5.74 | 11.5 | 23.3 | 35.3 | 60.2 | 127 |
| results | arithmetic average | | 1.7 | 1.4 | 1.6 | 1.2 | 1.0 | 1.5 |
| | roughness of plasma | | | | | | | |
| | treated face (nm) | | | | | | | |
| | arithmetic average | | 3.0 | 3.0 | 3.0 | 3.0 | 3.0 | 3.0 |
| | roughness of | | | | | | | |
| | untreated face (nm) | | | | | | | |
| | elemental | C | 88 | 87 | 87 | 87 | 87 | 88 |
| | composition | N | 3 | 1 | 1 | 1 | 1 | 2 |
| | ratio of the | O | 9 | 12 | 12 | 12 | 12 | 10 |
| | surface layer (%) | | | | | | | |
| | surface free | r_{L} | 73 | 75 | 74 | 73 | 76 | 73 |
| | energy | r_{L}^{d} | 28 | 28 | 28 | 29 | 29 | 29 |
| | | r_{L}^{p} | 30 | 32 | 30 | 31 | 33 | 30 |
| | | r_{L}^{h} | 15 | 15 | 14 | 13 | 14 | 14 |

| | | | | | | |
|---|---|---|---|---|---|---|
| peel strength (N/25 mm) | 0.7 | 0.8 | 0.7 | 1.1 | 1.2 | 1 |
| bend resistance (×10³ times) | 200 | 200 | 200 | 200 | 200 | 200 |
| heat resistant temperature (° C.) | 200 | 200 | 200 | 200 | 200 | 200 |

TABLE 3

| | | | Comparative Example | | | | | | | |
|---|---|---|---|---|---|---|---|---|---|---|
| | | | 1 | 2 | 3 | 4 | 5 | 6 | 7 | 8 |
| type of resin | | | A | A | A | A | A | A | A | B |
| plasma | gas ratio | N₂ | — | 100 | 99.9 | 97 | 98 | 85 | — | 95 |
| treatment | (% by | O₂ | — | 0 | 0.1 | 3 | 0 | 0 | — | 0 |
| condition | weight) | CO₂ | — | 0 | 0 | 0 | 2 | 15 | — | 5 |
| | weight ratio (O/N)(×10⁻³) | | — | 0 | 1.14 | 35.3 | 23.3 | 202 | — | 60.2 |
| results | arithmetic average | | — | 2.8 | 2.7 | 2.9 | 2.8 | 2.9 | 2.9 | 0.5 |
| | roughness of | | | | | | | | | |
| | treated face (nm) | | | | | | | | | |
| | arithmetic average | | both | 3.0 | 3.0 | 3.0 | 3.0 | 3.0 | 3.0 | 3.0 |
| | roughness of | | faces | | | | | | | |
| | untreated face (nm) | | 3.0 | | | | | | | |
| | elemental | C | 98 | 77 | 82 | 78 | 80 | 83 | 92 | 87 |
| | composition | N | 0 | 13 | 5 | 15 | 10 | 6 | 1 | 1 |
| | ratio of the | O | 2 | 10 | 11 | 4 | 10 | 11 | 7 | 12 |
| | surface layer (%) | | | | | | | | | |
| | surface free | r_{L} | 44 | 51 | 53 | 50 | 50 | 50 | 46 | 75 |
| | energy | r_{L}^{d} | 42 | 39 | 42 | 41 | 39 | 38 | 40 | 28 |
| | | r_{L}^{p} | 1 | 10 | 8 | 7 | 10 | 7 | 5 | 32 |
| | | r_{L}^{h} | 1 | 3 | 4 | 3 | 2 | 1 | 1 | 15 |

| | | | | | | | | |
|---|---|---|---|---|---|---|---|---|
| peel strength (N/25 mm) | 0.1 | 0.1 | 0.1 | 0.1 | 0.1 | 0.1 | 0.1 | 1.6 |
| bend resistance (×10³ times) | 200 | 200 | 200 | 200 | 200 | 200 | 200 | 25 |
| heat resistant temperature(° C.) | 200 | 200 | 200 | 200 | 200 | 200 | 200 | 165 |

Since the optical films obtained in Examples 1 to 6 have high peel strength, occurrence of delamination can be suppressed. Furthermore, since they have high bend resistance, the flexibility is excellent. In addition, they also have high heat resistance. Accordingly, they can be usefully used as, for example, a touch sensor, which is a component of a touch panel.

1. An optical film comprising, as a main component, a crystallized resin containing an alicyclic structure-containing polymer, wherein a crystallization degree of the crystallized resin is 30% or more, and an arithmetic average roughness of at least one face thereof is 2.5 nm or less.

2. The optical film according to claim 1, wherein
in a surface layer on the side of at least one face, a composition ratio of an oxygen element relative to a carbon element is 1/10 or more, and
a composition ratio of a nitrogen element relative to a carbon element is 1/20 or less.

3. The optical film according to claim 1, wherein,
at least one face has a total surface free energy of 70 mN/m or more, a surface free energy of a dispersive component of 40 mN/m or less, a surface free energy of a polar component of 25 mN/m or more, and a surface free energy of a hydrogen-bond component of 10 mN/m or more.

4. A method for producing the optical film according to claim 1, comprising:
a step of crystallizing a crystallizable resin film containing an alicyclic structure-containing polymer to obtain a crystallized resin film; and
a plasma treatment step of performing a plasma treatment on the crystallized resin film.

5. The method for producing the optical film according to claim 4, wherein the plasma treatment is performed under atmospheric pressure.

6. The method for producing the optical film according to claim 4, wherein
the plasma treatment is performed in a gas atmosphere,
the gas contains nitrogen gas, and also contains one or more gasses selected from oxygen gas and carbon dioxide gas, and
a weight ratio of oxygen relative to nitrogen in the gas is 5.50×10⁻³ or more and 1.30×10⁻¹ or less.

7. The method for producing the optical film according to claim 4, wherein
the plasma treatment is performed in a gas atmosphere,
the gas contains nitrogen gas and oxygen gas, and
a weight ratio of oxygen to nitrogen in the gas is 5.50×10⁻³ or more and 3.50×10⁻² or less.

8. The method for producing the optical film according to claim 4, wherein
the plasma treatment is performed in a gas atmosphere,
the gas contains nitrogen gas and carbon dioxide gas, and
a weight ratio of oxygen to nitrogen in the gas is 2.50×10⁻² or more and 1.30×10⁻¹ or less.

9. A multilayer film comprising:
the optical film according to claim 1;
an adherend layer; and
an adhesive layer provided between the optical film and the adherend layer.
